(19) United States
(12) Patent Application Publication
(10) Pub. No.: US 2020/0022424 A1
(43) Pub. Date: Jan. 23, 2020

(54) COMPRESSION PARTICULATE BLOCKING APPAREL

(71) Applicant: AEGIS Fire Gear LLC, Braselton, GA (US)

(72) Inventor: Chad Wenzel, Braselton, GA (US)

(73) Assignee: AEGIS Fire Gear LLC, Braselton, GA (US)

(21) Appl. No.: 16/452,242

(22) Filed: Jun. 25, 2019

Related U.S. Application Data
(60) Provisional application No. 62/700,994, filed on Jul. 20, 2018.
(60) Provisional application No. 62/821,433, filed on Mar. 20, 2019.
(60) Provisional application No. 62/857,196, filed on Jun. 4, 2019.

(51) Int. Cl. A41D 1/00

(52) U.S. Cl. CPC A41D 1/00; B32B 5/24

(57) ABSTRACT

An item of protective apparel can be formed from a compression particulate blocking fabric. The compression particulate blocking fabric may include an outer layer and a particulate blocking layer bonded to the outer layer. The particulate blocking layer is configured to block particulates within a predetermined size range from passing through the particulate blocking layer. The compression particulate blocking fabric may also include an inner layer bonded to the particulate blocking layer opposite to the outer layer. The compression particulate blocking fabric may also provide compression on a body part of a wearer of the item of protective apparel.

### CROSS REFERENCE TO RELATED APPLICATIONS

This application claims the benefit of U.S. Patent Application Ser. No. 62/700,994, which was filed on Jul. 20, 2018, U.S. Patent Application Ser. No. 62/821,433, which was filed on Mar. 20, 2019, and of U.S. Patent Application Ser. No. 62/857,196, which was filed on Jun. 4, 2019, each of which is incorporated herein by reference in its entirety.

### TECHNICAL FIELD

This disclosure relates to implementations of compression particulate blocking apparel and fabric for making such apparel. Example apparel includes shirts, shorts, pants and socks.

### BACKGROUND

This section provides background information related to the present disclosure which is not necessarily prior art.

According to some studies, firefighters have an increased risk of developing certain cancers in contrast to the U.S. population in general. According to such studies, these cancers include lung cancer, esophageal cancer, testicular cancer, prostate cancer, and colon cancer. According to The National Institute for Occupational Safety and Health (NIOSH), firefighters can be exposed to contaminants from fires that are known or suspected to cause such cancers. Such contaminants include combustion by-products such as benzene and formaldehyde and materials in debris such as asbestos from older structures. Firefighters are at risk of absorbing these contaminants through the skin, for example from soot deposited on firefighters' skin while fighting fires.

Existing products for firefighters, such as self-contained breathing apparatuses (SCBAs), hoods, pants, boots, and gloves, do not prevent soot or other contaminant sources from seeping through these products and depositing upon the wearer's skin. In particular, there does not exist effective gear to help protect sensitive body organs or areas, particularly in the portions of the trunk, pelvis, or legs, of firefighters and other first or emergency responders, military personnel, hazardous material personnel, or any other relevant personnel.

### SUMMARY

This section provides a general summary of the disclosure, and is not a comprehensive disclosure of its full scope or all of its features.

In one example in accordance with the present disclosure, an item of apparel can be formed from a compression particulate blocking fabric. The compression particulate blocking fabric may include an outer layer and a particulate blocking layer bonded to the outer layer. The compression particulate blocking fabric may also include an inner layer bonded to the particulate blocking layer opposite to the outer layer. The particulate blocking layer is configured to block particulates within a predetermined size range from passing through the particulate blocking layer. The compression particulate blocking fabric may also provide compression on a body part of a wearer of the item of apparel.

In one example in accordance with the present disclosure, a compression particulate blocking fabric may include a particulate blocking layer bonded between two elastic layers. The compression particulate blocking fabric can be operable in a relaxed and in an expanded state in which the fabric blocks particulates ranging from 0.1 microns to 1.0 microns in size.

In one example method in accordance with the present disclosure, a method of making a compression particulate blocking fabric is contemplated. The method may include laminating an outer layer to a particulate blocking layer, wherein the particulate blocking layer is configured to block particulates within a predetermined size range from passing through the particulate blocking layer. The method may also include allowing the laminated outer layer and particulate blocking layer to cure for a predetermined first cure time. The inner layer may then be laminated to the particulate blocking layer on a side of the particulate blocking layer opposite to the outer layer and allowed to cure for a second predetermined cure time.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration showing an exploded view of an example compression particulate blocking fabric of the present disclosure.

FIG. 2 is an illustration showing a cross-section of the example compression particulate blocking fabric of FIG. 1.

FIG. 3 is an illustration showing a cross-section of another example compression particulate blocking fabric of the present disclosure.

FIG. 4 is an illustration showing the example compression particulate blocking fabric of the present disclosure in a relaxed and in an expanded state.

FIG. 5 is an illustration of an example quilted configuration of the compression particulate blocking fabric of the present disclosure.

FIGS. 6A and 6B illustrate implementations of compression particulate blocking shorts made of the compression particulate blocking fabric of the present disclosure.

FIG. 7 illustrates an implementation of compression particulate blocking pants made of the compression particulate blocking fabric of the present disclosure.

FIG. 8 illustrates an example waist portion of the compression particulate blocking pants of FIG. 7.

FIG. 9 illustrates an implementation of a compression particulate blocking shirt made of the compression particulate blocking fabric of the present disclosure.

FIG. 10 illustrates an implementation of a compression particulate blocking sock made of the compression particulate blocking fabric of the present disclosure.

FIG. 11 illustrates an example method of making the compression particulate blocking fabric of the present disclosure.

FIG. 12 is a schematic illustration of an example lamination system that can be used during the fabrication of the compression particulate blocking fabrics of the present disclosure.

FIG. 13 is an image showing of other example articles of clothing that may incorporate the compression particulate blocking fabric of the present disclosure.

Corresponding reference numerals indicate corresponding parts throughout the several views of the drawings.

### DETAILED DESCRIPTION

Example embodiments and implementations will now be described more fully with reference to the accompanying drawings.

The example compression particulate blocking fabrics of the present disclosure can include one or more layers bonded together. The example compression particulate blocking fabrics provide comfort and various performance attributes for the user. The performance attributes of the compression particulate blocking fabric include numerous advantages for the user over traditional articles of clothing fabrics including the blocking of particulates, the wicking of moisture, thermal management and compression on covered body parts all in a durable material. The compression particulate blocking fabrics can combine one or more of these performance attributes in a single article of clothing that is comfortable for the wearer and able to withstand multiple washing cycles and exposure to extreme environments.

The example compression particulate blocking fabrics can be incorporated into or used to make various articles of clothing or other gear. The clothing and gear made from the example compression particulate blocking fabrics can be particularly suited for use in environments in which the users may be exposed to particulates or other undesirable contaminants that may cause detrimental health effects. In the context of the present disclosure, the term “particulates” is used to describe particulate matter and other contaminants that can pass through traditional materials and expose individuals in environments containing such particulates to heightened risk of detrimental health effects. Example environments include fire scenes, active firearm environments, military training environments, military engagements and the like. As can be appreciated, individuals that may benefit from using the articles of clothing and/or gear made from the example compression particulate blocking fabrics of the present disclosure include firefighters, police, other first responders, military members, hunters, and the like.

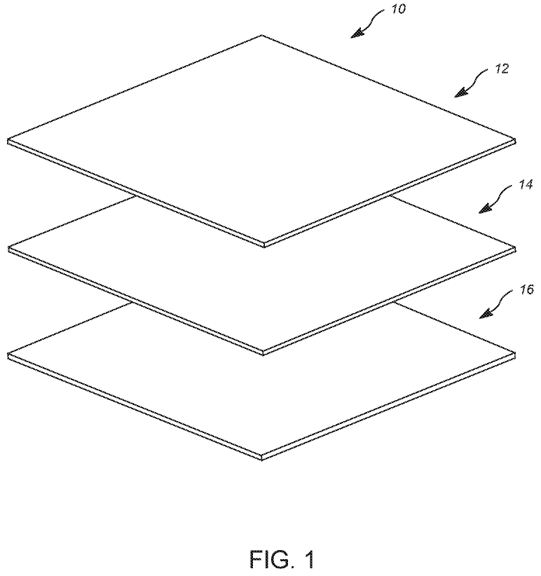

With reference to FIG. 1, an example compression particulate blocking fabric is shown. In the example, the compression particulate blocking fabric 10 can include a first (or outer) layer 12, a second (or blocking) layer 14 and a third (or inner) layer 16. The terms “outer” and “inner” or variations thereof may be used in the present disclosure to describe one or more elements of the example compression particulate blocking fabric or articles made from the example compression particulate blocking fabric. Use of such term is used for reference only and is used with reference to the body of a user. Thus, for purposes of the present disclosure, the term “outer” means away from the body of the user and the term “inner” means toward the body of the user unless the context and particular description of such element clearly states otherwise.

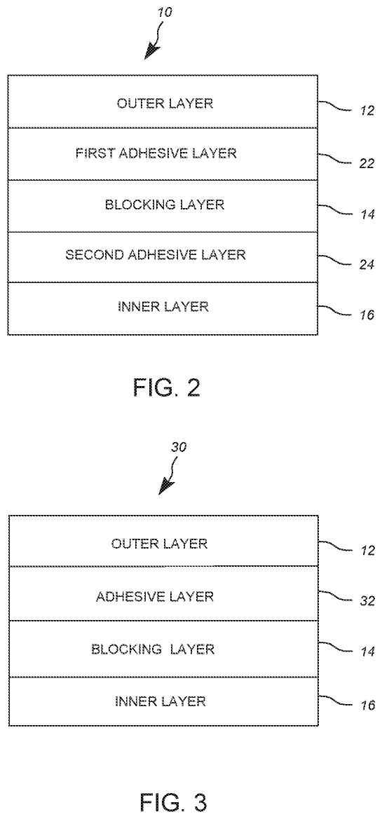

Referring back to FIG. 1, the first layer 12, the second layer 14 and the third layer 16 can be bonded together to define an integral compression particulate blocking fabric 10. As will be further described, any suitable bonding process can be used to secure the first layer 12, the second layer 14 and the third layer 16 into their relative positions to each other as shown. As shown in FIG. 2, the outer layer 12 can be bonded to the blocking layer 14 using a first adhesive layer 22. Similarly, the blocking layer 14 can be bonded to the inner layer 16 using a second adhesive layer 24. In some examples, the first adhesive layer 22 and/or the second adhesive layer 24 can be a thin film of suitable hot melt adhesive. In some instances, the film of adhesive can be discontinuous in the pre-melted state and have a net, web or other discontinuous configuration. In other instances, the first adhesive layer 22 and/or the second adhesive layer 24 can be a substantially continuous film of adhesive.

Referring now to FIG. 2, another example compression particulate blocking fabric 30 is shown. In this example, the outer layer 12 is bonded to the blocking layer 14 using an adhesive layer 32. The blocking layer 14, in this example, is directly bonded to the inner layer 16 as shown. In such an example the blocking layer 14 and/or the inner layer 16 can include a film, weave or other feature such that a separate layer of adhesive does not need to be applied during the forming process to bond the blocking layer 14 to the inner layer 16. For example, the inner layer 16 can include a fiber with hot-melt properties that can be interlaced in the material of the inner layer 16 or can include adhesive dots that can melt during a laminating process to join the inner layer 16 and the blocking layer 14 to one another. In still other examples, both the inner layer 16 and the outer layer 18 can include such integral features for bonding to the blocking layer 14 such that no separate adhesive layer such as layer 22, 24, or 32 is required to bond the outer layer 12, the blocking layer 14 and the inner layer 16 to each other.

In the example compression particulate blocking fabric 10, the outer layer 12, the blocking layer 14 and the inner layer 16 can provide the various performance attributes previously described. As such, the selection of each layer is chosen such that the composite of such layers advantageously provides the compression particulate blocking material that provides compression, particulate blocking, moisture management, comfort and durability.

In the example compression particulate blocking fabric 10, the outer layer 12 can be made of a 96% Polyester, 4% Spandex blend material. Such material provides excellent reliability and performance. In other examples, the compression particulate blocking fabric 10 can be a blend having a percentage of Polyester in the range of 85% to 98%, inclusive and a percentage of Spandex in the range of 15% to 2%, inclusive. In other example blends, the percentage of Polyester can be in the range of 90% to 98%, inclusive and the percentage of Spandex can be in the range of 10% to 2%, inclusive. In still other examples, the percentage of Polyester can be in the range of 95% to 98%, inclusive and the Spandex can be in the range of 5% to 2%, inclusive. As can be appreciated, the blend materials in foregoing ranges have percentages of Polyester and Spandex that add to 100%.

The outer layer 12 of the compression particulate blocking fabric 10 can have a circular weave with a material weight of 3 ounces per yard. Other material weights can also be used. For example, the compression blocking fabric 10 can be made in a winter weight and in a summer weight. In such examples, the winter weight compression particulate blocking fabric 10 can have an outer layer 12 with a weight of 5 ounces per yard and the summer weight can have a weight of 3 ounces per yard. In other examples, the outer layer can have other weights. In one example, the outer layer 12 and/or the inner layer 16 can have a weight between 6 ounces per yard and 1 ounces per yard. In another example, the outer layer 12 and/or the inner layer 16 can have a weight between or equal to 5 ounces per yard and 2 ounces per yard. In still another example, the outer layer 12 and/or the inner layer 16 can have a weight of at least 2.2 ounces per yard. In still other examples, the outer layer 12 can be made of other suitable blends or other materials.

The inner layer 16, in the example compression particulate blocking fabric 10, can be made of the same material as the outer layer 12. In the example shown, the inner layer 16 can be made of the 96% Polyester, 4% Spandex blend material. In other examples, the inner layer 16 can be made of a blend having the percentages of Polyester and Spandex described above with respect to the outer layer 12. The inner layer 16 can have a similar weight as the outer layer 12 such as 3 ounces per yard or 5 ounces per yard. In other examples, the winter weight compression particulate blocking fabric 10 can have an inner layer 16 with a weight of 5 ounces per yard and the summer weight can have a weight of 3 ounces per yard. In other examples, the inner layer can have other weights. In one example, the inner layer 16 can have a weight between 6 ounces per yard and 1 ounces per yard. In another example, the inner layer 16 can have a weight between or equal to 5 ounces per yard and 2 ounces per yard. In still another example, the inner layer 16 can have a weight of at least 2.2 ounces per yard. In other examples, the inner layer 16 can be made of a material different from the outer layer 12 and/or of different materials from those described above. In some examples, the inner layer 16 is made from a suitable material to provide comfort against the skin of a wearer of an article of clothing made with the compression particulate blocking fabric 10.

In other examples, the outer layer 12 and/or the inner layer 16 can be made of a 90% Polyester/10% Spandex material, a twill weave material, a twill rip stop material, a knit material or other materials such as a material sold under the names TECH T4™, TECH T5™ or other suitable fire resistance material. The outer layer 12 and/or the inner layer 16, in some examples, can be made of a material with particular resistance to heat, chemicals and/or radiation such as a flame-resistant meta-aramid material. Some example materials are sold under the names Nomex® and Tecasafe®.

The blocking layer 14 that is positioned between outer layer 12 and the inner layer 16 can provide the ability to block particulates from passing through the compression particulate blocking fabric 10. In the example shown, the blocking layer 14 can be made of an expanded polytetrafluoroethylene (ePTFE) material. In other examples, the blocking layer 14 can be made of another suitable polymer material such as polytetrafluorocarbon or polyurethane. Example materials for the blocking layer 14 are provided under the brand names StedAir® Prevent and Nomex® Nano Flex by Stedfast and DuPont, respectively.

The blocking layer 14 has various properties that can provide one or more of the performance attributes described above. The particulate blocking attributes of the blocking layer 14 can be performed, in one example, by one or more sub-layers of the blocking layer 14. In some examples, the blocking layer 14 can include a microporous membrane sub-layer that can block and/or filter particulates. The blocking layer 14 can also have a carrier sub-layer that can be made of a knit or woven material. The blocking layer 14 can also have a carbon sub-layer or other nanoparticle sub-layer that can absorb and/or filter particulates or hazardous contaminants.

The outer layer 12, the blocking layer 14 and the inner layer 16 can be combined and bonded together using any suitable method. In one example, the outer layer 12, the blocking layer 14 and the inner layer 16 are laminated together using a hot melt process. In such an example process, the outer layer 12 is laminated to the blocking layer 14. The combined layers are allowed to cure for a predetermined cure time. In one example, the cure time is at least 24 hours. In other examples, other cure times can be used such as less than 24 hours, or less than 12 hours. In other examples a minimum cure time is provided. In such examples, the minimum cure time can be 24 hours, 20 hours, 12 hours, or 6 hours. After the combined layers have cured, the combined layers are laminated to the inner layer 16. After the final lamination process, the combined compression particulate blocking fabric 10 can be allowed to cure for a second predetermined cure time. This second predetermined cure time can be the same cure time as any of the cure times described above. In other examples, the first predetermined cure time and the second predetermined cure time can be different.

The outer layer 12 and the inner layer 16 can be bonded to the opposite sides of the blocking layer 14 as previously described in order to provide a fabric with the particulate blocking performance as well as providing compression and elasticity as will be further described below. The outer layer 12 can first be bonded to the blocking layer 14 in order to fully cure the bond between the outer layer 12 and the blocking layer 14 before the inner layer 16 is added. In one example bonding process, the outer layer 12 and the blocking layer 14 are dispensed from large rolls of each material. As the two materials are dispensed into a suitable laminating machine, tension is applied thereto. The tension that is applied to the outer layer 12, however, is closely monitored in order to ensure that a damaging tension level is not applied to the blocking layer 14. If the outer layer 12 is tensioned with a tension level above a predetermined threshold, the outer layer 12 can be bonded to the blocking layer 14 in a tensioned condition. In such tensioned condition, the blocking layer 14 may not be able to further stretch without tearing, separating or bursting. In light of this undesirable condition, the outer layer 12 is tensioned below the predetermined tension threshold during the bonding process to prevent the blocking layer 14 from being bonded in a pre-stressed condition.

The outer layer 12 and the blocking layer 14 can be allowed to fully cure so that the same or similar process can be conducted to bond the inner layer 16 to a side of the blocking layer 14 opposite to the inner layer 12. In such similar process, the inner layer 16 can be tensioned below the predetermined tension threshold during the bonding process to prevent the blocking layer 14 from being bonded in a pre-stressed condition.

As can be appreciated, the process can be varied such that the inner layer 16 is bonded to the blocking fabric 14 in a first step and allowed to cure. The outer layer 12 can be bonded to the blocking fabric 14 on a side opposite to the inner layer 16 in as second step. The bonded fabric can be allowed to cure after such second step.

The compression particulate blocking fabric 10 can have various performance attributes. An example first performance attribute is the ability of the compression particulate blocking fabric to provide compression to the wearer. Articles of clothing made from the compression particulate blocking fabric 10 can be tight fitting to a wearer. This enables such articles of clothing to be easily worn as undergarments under other items of clothes such as uniforms, workwear, protective overgarments and the like. Compression clothing can improve blood flow to the muscles of the wearer to improve endurance and muscular performance.

The compression particulate blocking fabric 10 can have an elastic characteristic that can provide a compressive pressure of up to 30 mmHG (millimeters of mercury) to the wearer. In some examples, the compression particulate blocking fabric 10 can provide a compressive pressure of at least 30 mmHG. In other examples, the compression particulate blocking fabric 10 can provide a compressive pressure in the range of 5 to 30 mmHG. In other examples, the compression particulate blocking fabric 10 can provide a compressive pressure in the range of 15 to 40 mmHG. In other examples, the compression particulate blocking fabric 10 can provide a suitable level of compression to improve endurance and/or to improve the muscular performance of the wearer.

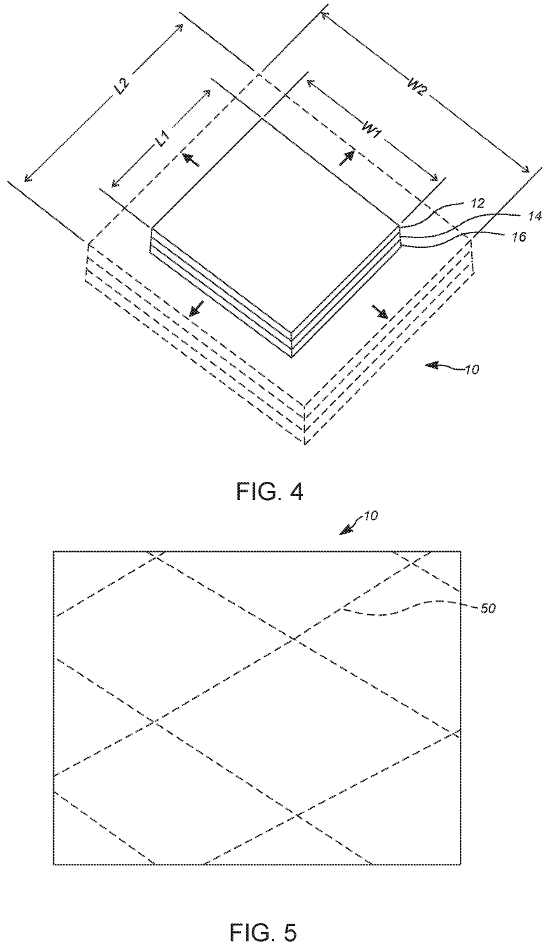

As described, the compression particulate blocking fabric 10 can have an elastic characteristic. As shown in FIG. 4, the compression particulate blocking fabric 10 can extend from a relaxed state (shown in solid lines) to an expanded state (shown in dashed lines) when an external force is applied to the fabric. As shown, the compression particulate blocking fabric 10 can have a length L1 and a width W1 when in the relaxed state. In the expanded state, the compression particulate blocking fabric 10 can have a length L2 and a width W2. As seen, the length L2 and the width W2 in the expanded state are greater than length L1 and the width W1 in the relaxed state. The compression particulate blocking fabric 10 can move from the relaxed state to the expanded state repeatedly without tearing, separating or bursting. Such an elastic property of a fabric that includes a material with particulate blocking attributes, such as blocking layer 14, can be particularly difficult. The compression particulate blocking fabric 10 of the present disclosure is unique in this regard by providing elasticity and the associated compression attribute while also incorporating the particulate blocking properties as well.

In the example shown, the compression particulate blocking fabric 10 can have an elastic property of at least 10%. This percentage elasticity can be calculated using the formula (L2−L1)/L1 or (W2−W1)/W1. The lengths and widths of the fabric 10 can be measured on a predetermined swatch of the fabric in the relaxed and expanded states. In other examples, the compression particulate blocking fabric 10 can have an elasticity of at least 15%. In still another example, the compression particulate blocking fabric 10 can have an elasticity of at least 20%. In yet another example, the compression particulate blocking fabric 10 can have an elasticity of at least 30%. In still another example, the compression particulate blocking fabric 10 can have an elasticity of at least 40%. As shown, the compression particulate blocking fabric 10 can be a two-way stretch material that stretches both in the length direction and in the width direction. In other examples, the compression particulate blocking fabric 10 can be a one-way stretch material or can have asymmetrical elastic properties such that the percentage elasticity differs between the length direction and the width direction.

A second performance attribute of the compression particulate blocking fabric 10 is the ability of the fabric to block particulates or other contaminants. One example test that can be used to measure this performance attribute is ASTM F2299. The compression particulate blocking fabric 10 can meet the standards set forth in the National Fire Protection Association (NFPA) 1971 Standard, 2018 Edition. In particular, the compression particulate blocking fabric 10 can block particulates having a size of 0.1 μm to 1.0 μm at an efficiency of at least 90%. In another example, the compression particulate blocking fabric 10 can block particulates having a size of 0.1 μm to 1.0 μm at an efficiency of at least 95%. In a preferred example, the compression particulate blocking fabric 10 can block particulates having a size of 0.1 μm to 1.0 μm at an efficiency of at least 98%.

In other examples, the compression particulate blocking fabric 10 can perform at the efficiency levels previously described but can be configured to block particulates having sizes other than those described above. In such examples, the compression particulate blocking fabric 10 can block particulates having sizes less than 0.1 μm. In other examples, the compression particulate blocking fabric 10 can block particulates having sizes greater than 0.1 μm. In still other examples, the compression particulate blocking fabric 10 can block particulates having sizes greater than 1.0 μm.

The durability of the compression particulate blocking fabric 10 is another performance attribute that differentiates this fabric from other fabrics. The compression particulate blocking fabric 10 can provide the particulate blocking performance after repeated use and washing. For example, the compression particulate blocking fabric 10 can be subjected to washing and conditioning testing such as those described in the American Association of Textile Chemists and Colorists (AATCC) Test Method 135 and/or in ASTM D 1776. After such washing and/or conditioning, the compression particulate blocking fabric 10 can block particulates of the size and at the efficiencies previously described.

Another performance attribute of the compression particulate blocking fabric 10 is the ability to wick and/or manage moisture from a user's skin. The compression particulate blocking fabric has superior wicking and/or moisture management properties. The ability of the compression particulate blocking fabric 10 to transfer moisture can be tested using AATCC Test Method 197-2011, AATCC Test Method 198-2011 and/or AATCC Test Method 199-2011. The compression particulate blocking fabric 10 can transfer moisture away from a wearer's skin to assist in managing the temperature of the wearer's body. In warm environments, such moisture management or wicking property can assist in moving moisture away from the skin to evaporate and assist in cooling the wearer. In cool environments, the moisture management and/or wicking property can assist in moving moisture away from the wearer's skin to prevent the moisture from becoming cold against the wearer's skin and causing the wearer to feel cold.

In one example, the compression particulate blocking fabric 10 can have a property that prevents the flow of liquids, such as liquid water, through the fabric 10. The compression particulate blocking fabric 10, however, can permit the transfer of vapor, such as water vapor, through the fabric. In such examples, the compression particulate blocking fabric 10 may not allow liquid water to be transferred from the inner layer 16 to the outer layer 12 through the blocking layer 14. Such a property can advantageously permit moisture to move away from a wearer's skin as previously described.

Another performance attribute of the compression particulate blocking fabric 10 is the ability of the fabric to provide cooling or thermal management to a user. As can be appreciated, if an individual is wearing an article of clothing produced with the compression particulate blocking fabric, it can be advantageous for the fabric to cool the body the wearer (or to assist in maintaining warmth in a cool environment). This property can be particularly useful in instances where the individual is engaged in rigorous activity or is engaged in an environment with elevated temperatures. Firefighters, emergency personnel, other first responders and military personnel can particularly take advantage of such a thermal management property. To assist in this regard, the compression particulate blocking fabric can be air permeable while still providing the particulate blocking attributes described above. For example, the compression blocking fabric can be tested using ASTM D737. The compression particulate blocking fabric 10, in one example, can permit an airflow to pass through the fabric with a volumetric flow rate in the range of 5 to 10 cubic feet per minute (cfm). In another example, the compression particulate blocking fabric 10 can permit an airflow to pass through the fabric at a volumetric flow rate in the range of 6 to 8 cfm. In another example, the compression particulate blocking fabric 10 can permit an airflow to pass through the fabric of at least 5 cfm. In still another example, the compression particulate blocking fabric can permit an airflow to pass through the fabric of at least 6 cfm. In other examples, the compression particulate blocking fabric 10 can permit an airflow to pass through the fabric at a volumetric flow rate that permits sufficient thermal management for the wearer.

Another performance attribute of the compression particulate blocking fabric 10 is that the fabric has a reduced susceptibility to piling than traditional fabrics. The compression particulate blocking fabric 10 can be testing using ASTM D 3512. This test, for example, subjects the fabric to a random tumble piling tester. The amount of piling of the fabric is then measured. The compression particulate blocking fabric 10 is durable to allow continued performance after completion of 100 wash cycles without having an undesirable appearance from piling or otherwise.

In addition to blocking particulates, the compression particulate blocking fabric 10 may provide a scent or odor blocking feature or property. For example, in some implementations, the blocking layer 14 of the compression particulate blocking fabric 10 may prevent a body scent or odor of a wearer of the compression particulate blocking garment (i.e., the shirt, shorts, and/or pants) from passing through the blocking layer 14 of the garment. In this way, in some implementations, the wearer of the garment may use this scent or odor blocking property while hunting to contain the body scent of the wearer within the garment, e.g. to avoid scaring off hunting game.

In various implementations, the compression particulate blocking fabric 10 can be used to produce compression particulate blocking articles of clothing, gear and/or other protective equipment. For example, compression particulate blocking shirts, shorts, and pants can be produced. In some examples, such articles of clothing can be worn as undergarments under other protective equipment, uniforms or outer clothing. In other examples, the compression particulate blocking fabric 10 can be incorporated and/or used to produce outer clothing items, uniforms and other gear.

As shown in FIG. 5, the compression particulate blocking fabric 10 can have a quilted configuration. In such a quilted configuration, the compression particulate blocking fabric 10 can include a pattern of sew lines 50 or other features that are repeated across the fabric. In the example shown, the sew lines 50 form a repeated diamond pattern across the fabric. In other examples, the compression particulate blocking fabric 10 can have other surface patterns and/or quilted configurations having different shapes. The compression particulate blocking fabric 10 can also have a substantially smooth and/or uninterrupted surface without the sew lines 50.

As can be appreciated, the compression particulate blocking shorts, pants, and shirts of the present disclosure are configured to prevent or reduce soot or other fire contaminant sources from seeping through the compression particulate blocking shorts, pants, and shirt and depositing upon a wearer's skin. As such, the compression particulate blocking shorts, pants, and shirts are configured to prevent or reduce particulate penetration into areas of a wearer's body that are covered by the compression particulate blocking shorts, pants, and shirt.

The compression particulate blocking shorts, pants, and shirt can also provide other advantages over traditional articles of clothing. For example, the compression particulate blocking articles of clothing can provide thermal protection to areas of a wearer's body that are covered by the compression particulate blocking shorts, pants, and shirt. In addition (and as described above) the compression particulate blocking shorts, pants, and shirts are configured to provide compression to areas of a wearer's body that are covered by the compression particulate blocking shorts, pants, and shirt.

In the context of firefighters, traditional protective gear does not prevent all particulates and/or contaminants from being deposited or contacting a wearer's skin. For example, protective outer wear of firefighters can include hoods, coats, pants, overalls, boots, helmets, gloves and the like. Such so-called turn-out gear or bunker gear can often include ingress portions through which particulates or contaminants can enter and be exposed to a wearer's skin. Such ingress portions can include cuffs, zippers, hook and loop fastened openings and the like. The compression particulate blocking articles of clothing of the present disclosure can be worn under the turn-out gear to provide continued protection against particulates or contaminants that may enter the outer layer of protection that turn-out gear can provide.

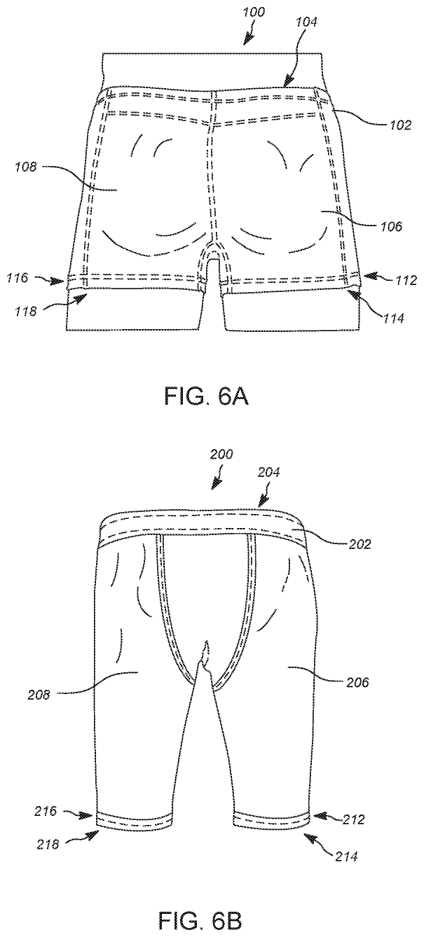

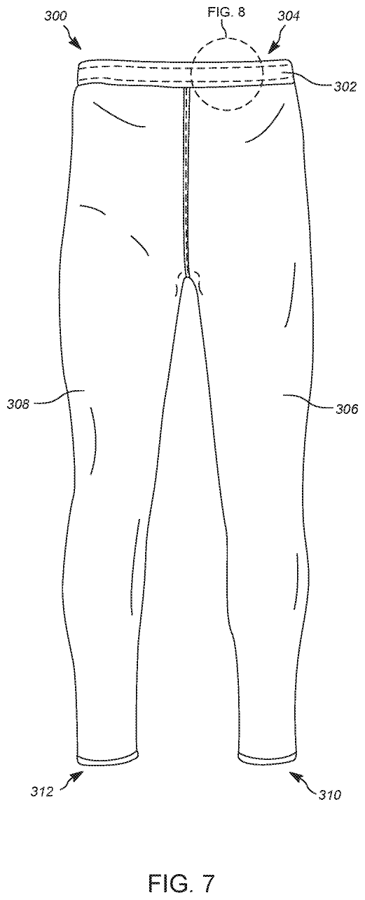

FIGS. 6A and 6B illustrate implementations of example compression particulate blocking shorts 100, 200 of the present disclosure.

The example compression particulate blocking shorts 100, 200 can be produced using the compression particulate blocking fabric 10. The compression particulate blocking fabric can be cut in the appropriate shape and sewn together using a universal size flatlock stitch. The stitch provides comfort for the wearer and also can ensure that the finished product maintains a 100% particulate protection for the wearer. The compression particulate blocking shorts 100, 200 are made of one or more pieces of the compression particulate blocking fabric 10 with particulate resistant seams (i.e., particulates of the sizes and in the efficiencies previously described are unable to penetrate the seams).

As shown, the compression particulate blocking shorts 100, 200 may include a waist portion 102, 202 having a waist opening 104, 204, a right leg portion 106, 206 extending from the waist portion 102, 202, and a left leg portion 108, 208 extending from the waist portion 102, 202, respectively. The distal end 112, 212 of the right leg portion 106, 206 can include a right leg opening 114, 214, respectively. Similarly, the distal end 116, 216 of the left leg portion 108, 208 can include a left leg opening 118, 218, respectively. The waist portion 102, 202 around the waist opening 104, 204, respectively, is elastic. In some implementations, the waist portion 102, 202 around the waist opening 104, 204, respectively, can be any other suitable material that functions similarly to elastic.

The distal ends 112, 212, 116, 216 of the leg portions 106, 206, 108, 208 around the leg openings 114, 214, 118, 218, respectively, can be elastic. In some implementations, the distal ends 112, 212, 116, 216 of the leg portions 106, 206, 108, 208 around the leg openings 114, 214, 118, 218, respectively, can be any other suitable material that functions similarly to elastic.

The compression particulate blocking shorts 100, 200 can be are configured to be tight fitting around the waist opening 104, 204 and the leg openings 114, 214, 118, 218 to prevent particulate penetration into the areas of a wearer's body that are covered by the compression particulate blocking shorts 100, 200. In some implementations, the compression particulate blocking shorts 100, 200 are configured to have any other suitable fit around the waist openings 104, 204 and the leg openings 114, 214, 118, 218 to prevent particulate penetration into the areas of a wearer's body that are covered by the compression particulate blocking shorts 100, 200, respectively such as draw strings, tightening straps, ribbing or the like.

In some implementations, the compression particulate blocking shorts 100, 200 are similar to a football girdle. In some implementations, the compression particulate blocking shorts 100, 200 are similar to any other suitable form of shorts. As shown, the compression particulate blocking shorts 100 may extend to above mid-thigh as shown in FIG. 6A. In other implementations, the compression particulate blocking shorts 200 extend below mid-thigh to above the knee as shown in FIG. 6B.

As shown in FIG. 7, the compression particulate blocking material 10 can be used to produce compression particulate blocking pants 300. The compression particulate blocking pants 300 may include a waist portion 302, a waist opening 304, a right leg portion 306, a left leg portion 308, a right leg opening 310, and a left leg opening 312 that are substantially the same or similar respectively, except for the length of the leg portions 306, 308 to the waist portion 102, 202, the waist opening 104, 204, the right leg portion 106, 206, the left leg portion 108, 208, the right leg opening 114, 214 and the left leg opening 118, 218 of the above described compression particulate blocking shorts 100, 200 of FIGS. 6A and 6B, respectively.

In some implementations, the compression particulate blocking pants 300 have substantially the same or similar functionality as the above described compression particulate blocking shorts 100, 200.

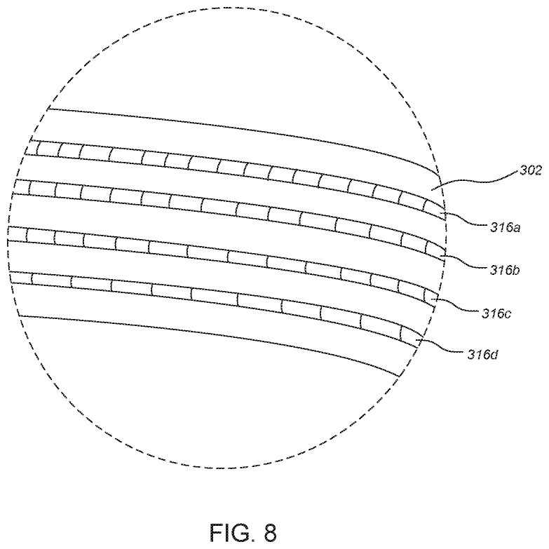

As shown in FIG. 8, the waist portion 302 of the compression particulate blocking pants 300 can include one or more features to maintain the position of the pants 300 at a desired position on the wearer and/or to keep a shirt tucked into the waist portion 302. In the example shown, the waist portion 302 includes four grips 316a, 316b, 316c, 316d. The grips 316 can be positioned substantially parallel to one another as shown. The grips 316 can be made of silicone material with a higher coefficient of friction than that of the material of the surrounding waist portion 302. In this manner, the grips 316 can prevent the waist portion 302 from undesirable movements relative to the wearer and/or keep a shirt tucked into the waist portion 302.

In other examples, the waist portion 302 can include more or fewer than four grips 316. Still further, the grips 316 can be configured as a series of dots or other discontinuous shapes along the waist portion 302 rather than the continuous lines of material as shown. The grips 316 can also be positioned on other portions of the other articles of clothing of the present disclosure. For example, the grips 316 can be positioned on the waist portions 102, 202 of the compression particulate blocking shorts 100, 200, respectively.

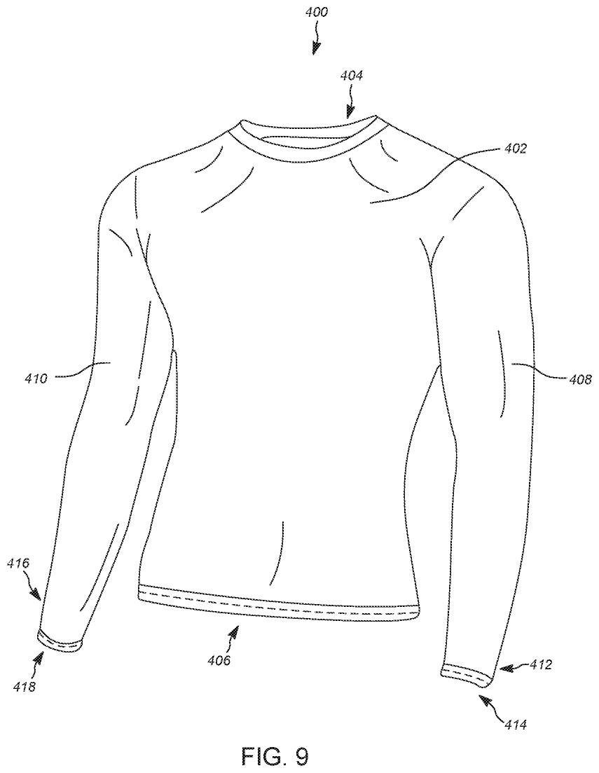

FIG. 9 illustrates an implementation of an example compression particulate blocking shirt 400 of the present disclosure. The compression particulate blocking shirt 400 can be produced from the compression particulate blocking fabric 10. As shown, the compression particulate blocking shirt 400 can include a torso portion 402 having a neck opening 404 and a torso opening 406, a right arm portion 408 extending from the torso portion 402, and a left arm portion 410 extending from the torso portion 402. In some implementations, the compression particulate blocking shirt 400 is long-sleeved (e.g., the right arm portion 408 and left arm portion 410 extend to the wrist area of the user). In other implementations, the compression particulate blocking shirt 400 can be short-sleeved. In other implementations, the right arm portion 408 and left arm portion 410 is any suitable length.

The compression particulate blocking shirt 400 can include a distal end 412 of the right arm portion 408 can have a right arm opening 414. Similarly, a distal end 416 of the left arm portion 410 can include a left arm opening 418.

In some implementations, the distal ends 412, 416 of the arm portions 408, 410 around the arm openings 414, 418, respectively, are elastic. In other implementations, the distal ends 412, 416 of the arm portions 408, 410 around the arm openings 414, 418, respectively, are any other suitable material that functions similarly to elastic.

The compression particulate blocking shirt 400 is configured to be tight fitting around the neck opening 404 and the arm openings 414, 418 to prevent particulate penetration into the areas of a wearer's body that are covered by the compression particulate blocking shirt 400. In some implementations, the compression particulate blocking shirt 400 is configured to have any other suitable fit around the neck opening 404 and the arm openings 414, 418 to prevent particulate penetration into the areas of a wearer's body that are covered by the compression particulate blocking shirt 400. As such, the compression particulate blocking shirt 400 can have similar functionality to the above described compression particulate blocking shorts 100, 200.

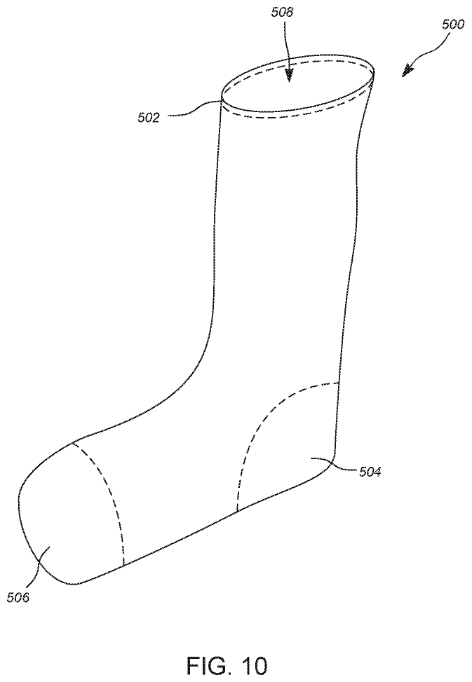

FIG. 10 illustrates an implementation of a compression particulate blocking sock 500 of present disclosure. The compression particulate blocking sock 500 can be made of the compression particulate blocking fabric 10. As shown, the compression particulate blocking sock 500 can include a cuff portion 502, a heel portion 504 and a toe portion 506. The cuff portion 502 can define a cuff opening 508. The cuff portion 502 can be tight fitting so as to prevent particulates or contaminants from entering through the cuff opening 508 when the compression particulate blocking sock 500 is worn by a wearer. The distance between the heel portion 504 and the cuff portion 502 can be any suitable distance. In some examples, the distance from the heel portion 504 to the cuff portion 502 is such that the sock 500 is similar to a crew length sock. In other examples, the distance between the heel portion 504 and the cuff portion 502 is such that the sock 500 is similar to a knee-high sock. In other examples, the compression particulate blocking sock 500 can have other suitable lengths to cover more or less of a leg of a wearer.

The compression particulate blocking shorts 100, 200, or pants 300 of the present disclosure can provide protection to all or one or more portions of at least one of the following regions of a wearer's body:
the abdominal region encompassing the stomach area;
the umbilicus or naval;
the coxal region encompassing the belt line;
the pubic region encompassing the area above the genitals;
the inguinal or groin region between the legs and the genitals;
the pubic region surrounding the genitals;
the femoral region encompassing the thighs;
the patellar region encompassing the knee;
the popliteal region encompassing the back of the knee;
the crural region encompassing the shin area of the leg;
the fibular region encompassing the outside of the lower leg;
the sural region encompassing the back of the lower leg; or
the gluteal region encompassing the buttocks.

The compression particulate blocking shirt 400 of the present disclosure can provide protection to all or one or more portions of at least one of the following regions of a wearer's body:
the chest;
the abdominal region encompassing the stomach area;
the umbilicus or naval;
the back;
the shoulders; and
the arms.

While the above describes certain articles of clothing, it can be appreciated that the compression particulate blocking fabric 10 can be used to produce other articles of clothing and/or other equipment. For example, the compression particulate blocking fabric 10 can be used to produce gloves, hats, scarves, handkerchiefs, masks, gaiters, shoes, boots, and the like. The fabric can also be used to create equipment including bags, backpacks, wraps, blankets, curtains, and the like.

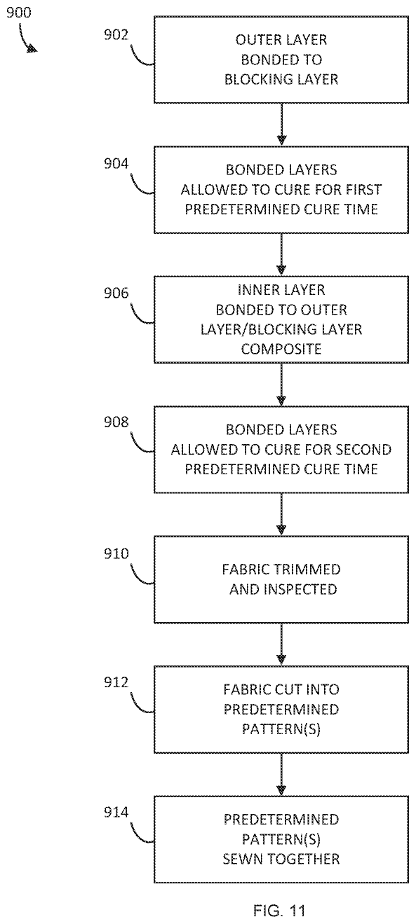

As described above, the compression particulate blocking fabric 10 can be manufactured using any suitable method. The fabric can then be used to produce one or more of the articles previously described. FIG. 11 illustrates one example method 900 of making an article from the compression particulate blocking fabric 10.

At step 902, the outer layer 12 is bonded to the blocking layer 14. Any suitable bonding technique can be used at step 902. For example, the outer layer 12 can be laminated to the blocking layer 14 using a hot melt laminating process. In other examples, the outer layer 12 is bonded to the blocking layer 14 using a flame, aqueous or solvent-based laminating process.

At step 904, the bonded composite of the outer layer 12 and the blocking layer 14 is allowed to cure for a first predetermined cure time. As previously stated, the predetermined cure time can be any suitable length of time in which the bond is sufficiently complete. In one example, the predetermined cure time is at least 24 hours.

At step 906, the inner layer 16 is bonded to the composite of the outer layer 12 and the blocking layer 14 on a side of the blocking layer 14 opposite to the outer layer 12. Any suitable bonding technique can be used. For example, the inner layer 16 can be bonded to the composite using a hot melt laminating process. In other examples, the inner layer 16 is bonded to the blocking layer 14 using a flame, aqueous or solvent-based laminating process.

At step 908, the three-layer composite is allowed to cure for a second predetermined cure time. The second predetermined cure time can be the same as or different from the first predetermined cure time. In one example, the second predetermined cure time is at least 24 hours.

At step 910, the three-layer composite has been formed into the compression particulate blocking fabric 10. At step 910, the compression particulate blocking fabric can be trimmed and inspected. At this step, the fabric 10 is inspected to ensure that the layers are properly bonded and no anomalies are identified.

At step 912, the compression particulate blocking fabric 10 can be cut into the appropriate shapes according to a predetermined pattern for a particular article of clothing (or other piece of equipment/gear).

At step 914, the cut pieces of the compression particulate blocking fabric 10 can be sewn together to form the desired article of clothing (or other piece of equipment/gear). A universal size flatlock stick can be used to sew the pieces of compression particulate blocking fabric 10 together.

After step 914, the article of clothing has been produced and can be sold, worn or otherwise used as intended.

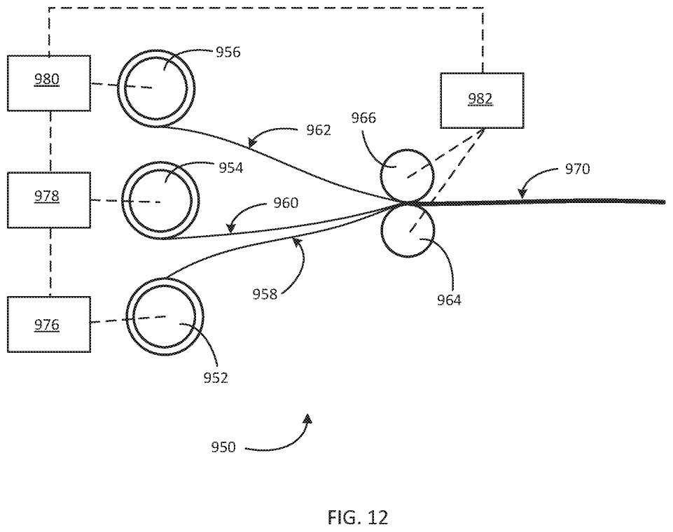

An example bonding system 950 is depicted in FIG. 12. The bonding system 950 can include a first dispenser 952, a second dispenser 954, a third dispenser 956 and a first bonding roller 964 and a second bonding roller 966. The bonding system 950 can further include a first tension controller 976, a second tension controller 978 and a third tension controller 980 in communication with and/or coupled to the first dispenser 952, the second dispenser 954 and the third dispenser 956, respectively.

In the example shown, the bonding system 950 can be used, for example, to bond the outer layer 12 to the blocking layer 14 using the first adhesive layer 22. Such a process, for example, can occur during step 902 of the example method 900 previously described. In an instance where the bonding system 950 is used to bond the outer layer 12 to the blocking layer 14 using the first adhesive layer 22, the first dispenser 952 can be loaded with a roll of material suitable for the outer layer 12. The second dispenser 954 can be loaded with a roll of material suitable for the adhesive layer 22 and the third dispenser 956 can be loaded with a roll of material suitable for the blocking layer 14.

The respective materials can be fed from the respective dispensers to a position between the first bonding roller 964 and the second bonding roller 966. In one example, the materials can be bonded together using a hot melt lamination process. In such a process, the first bonding roller 964 and the second bonding roller 966 can be heated to a suitable temperature to cause the material 960 of the adhesive layer 22 to melt and bond the material 958 to the material 962 as the multiple layers pass between the first bonding roller 964 and the second bonding roller 966. After passing between the bonding rollers 964, 966, the resulting bonded layers form a composite material that can then be allowed to cure to allow the materials 958, 962 to be secured relative to one another.

As previously described, it can be important not to place the material of the blocking layer 22 under too great of a tension during the bonding process so as not to damage the blocking layer 22 or to cause the blocking layer 22 to exhibit a pre-tensioned condition. If the blocking layer 22 is bonded in a pre-tensioned condition, the blocking layer 22 can rip, tear or otherwise rupture when the compression particulate blocking fabric 10 is stretched. Such rupture can negate the compression particulate blocking fabric's ability to block particulates and contaminants as previously described.

Given the aforementioned condition, the tension placed on the materials 958, 960, 962 can be closely monitored and/or controlled to prevent one or more of the materials 958, 960, 962 from being tensioned above the predetermined tension threshold. To assist in this regard, the first dispenser 952, the second dispenser 954 and/or the third dispenser 956 can be coupled to the first tension controller 976, the second tension controller 978, and/or the third tension controller 980, respectively. The tension controllers 976, 978, 980 can operate to dispense the respective materials at appropriate rates and/or with appropriate resistance to cause the tension of the materials 958, 960, 962 to remain at or below the predetermined tension thresholds.

The first tension controller 976, the second tension controller 978 and the third tension controller 980 can be any suitable controller that operates as previously described. The tension controllers 976, 978, 980 can be, for example, mechanical controllers such as a clutch, brake or the like that operates to maintain the tension at the appropriate levels. The tension controllers 976, 978, 980 can include electrical or pneumatic controls and can be coupled accordingly to the first dispenser 952, second dispenser, 954, and third dispenser 956. In other examples, the tension controllers 976, 978, 980 can include controllable motors, stepper motors or the like that are coupled to the first dispenser 952, second dispenser, 954, and third dispenser 956.

In other examples, the tension controllers 976, 978, 980 can be electronically controlled controllers such as a PLC or a micro-controller. Still further, the tension controllers 976, 978, 980 can include suitable processors, memory and/or executable instructions that cause the tension controllers 976, 978, 980 to maintain and/or adjust the tension of the materials 958, 960, 962 as previously described. As can be appreciated, the controllers can include or be coupled to suitable sensors such as force sensors, hall sensors or the like for monitoring the rates of the dispensers 952, 954, 956 and/or the tension of the materials 958, 960, 962. As can be appreciated, the controllers 976, 978, 980 can be connected with wired or wireless connections to other computing devices such that the operation of the bonding system 950 can be adjusted, monitored and/or controlled either locally or remotely.

As further shown, the bonding rollers 966, 964 can be coupled to a roller controller 982. The roller controller 982 can be similar to the tension controllers 976, 978, 980 previously described and can operate to adjust a rate and/or resistance of the bonding rollers 964, 966 to cause the tension of the materials 958, 960, 958 and the bonded material 970 to be maintained at or below the respective predetermined tension threshold(s). As further shown, the bonding controller 982, the first tension controller 976, the second tension controller 978 and/or the third tension controller 980 can be operatively coupled to each other to share data and signals regarding the operation of the one or more elements of the bonding system 950.

As can be appreciated, the bonding system 950 can be varied or altered such that it can be used during the second bonding step 906 of the method 900. In such a step, the inner layer 16 can be bonded to the composite bonded material produced during step 902 of the method 900. One or more elements of the bonding system 950 can also be used to create one or more of the other compression particulate bonded fabrics described in the present disclosure.

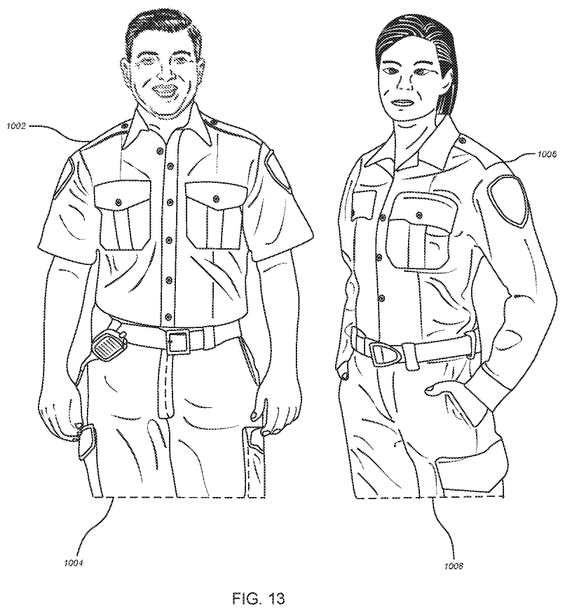

Turning now to FIG. 13, the apparel or article(s) of clothing produced from the compression particulate blocking fabric 10 can be, for example, the compression particulate blocking shorts, pants or shirt as previously described. These articles of clothing can be intended to be worn under other protective gear or under a uniform. In other examples, the outer wear (as shown in FIG. 13) can be produced from the compression particulate blocking fabric 10. As shown, such outer wear can include a short-sleeve uniform shirt 1002, uniform pants 1004, a long-sleeve uniform shirt 1006, or cargo pants 1006. In other examples, the compression particulate blocking fabric 10 can be used to produce outer wear in the nature of T-shirts, polo shirts and the like. In other examples, other articles of clothing can also be produced from the compression particulate fabric such as trousers, socks, hats, scarves, gloves and the like.

In other implementations, the various apparel or articles of clothing of the compression particulate blocking fabric can include accessories or other technology that can be combined into or used in connection therewith. For example, technology or accessories such as heart rate monitors or various other sensors can be used with or incorporated into the articles of clothing. Such sensors can include temperature sensors, blood pressure sensors, oxygen sensors, heart electrical activity sensors, respiratory rate sensors and the like. Other technology that can be used with or incorporated into the articles of clothing include communication systems, safety alert monitors, environmental contamination measurement devices and the like. In addition, the articles of clothing can include pockets, chambers, channels, electrical conduits or other features to assist in the connection of and use of such technology and/or sensors.

The compression particulate blocking fabric 10 and the articles of clothing, equipment and/or gear can provide numerous advantages for the wearer/user. The articles of clothing most particularly are comfortable and durable while providing life-changing levels of protection to individuals exposed to particulates, contamination and other hazardous substances. By blocking such particulates, the wearers of the articles of clothing made from the compression particulate blocking fabric 10 can be protected from excessive exposure to the health threatening materials.

### Test Example 1

One test example of the compression particulate blocking fabric was tested to determine its performance with respect to one or more of the performance attributes previously described. In such test example 1, the compression particulate blocking fabric included an outer layer of 90% Polyester and 10% Spandex. The blocking layer comprised a layer of particulate blocking material sold by the organization Stedfast under the name Stedair® PREVENT. The outer layer and the inner layer comprised material having weights of 5 ounces per yard. The material is the so-called winter weight material.

The outer layer was bonded to the blocking layer using an adhesive layer in a hot melt laminating process and allowed to cure for 24 hours. The inner layer was bonded to the blocking layer opposite to the outer layer using a hot melt laminating process and allowed to cure for 24 hours. The resulting material was made into a sample compression short and into a compression shirt.

The test example was tested according ASTM 737 for air permeability. A MO21A Air Permeability Tester was used. In the test, a test area of 38 square centimeters is tested at a test pressure of 125 Pascals (Pa). The airflow permitted through the test area of the test example fabric is shown below in cubic feet per minute (cfm).

TABLE 1
Compression Short Air Permeability Test Results
Compression Short

| Range | Sample Location | Air Permeability (cfm) | Avg. CFM | STDEV |
|---|---|---|---|---|
| Auto | 1 | 7.60 | 7.26 | 0.7 |
| | 2 | 6.80 | | |
| | 3 | 6.43 | | |
| | 4 | 7.79 | | |
| | 5 | 7.83 | | |
| | 6 | 7.45 | | |
| | 7 | 7.99 | | |
| | 8 | 7.88 | | |
| | 9 | 6.78 | | |
| | 10 | 6.08 | | |

TABLE 2
Compression Shirt Air Permeability Test Results
Compression Shirt

| Range | Sample Location | Air Permeability (cfm) | Avg. CFM | STDEV |
|---|---|---|---|---|
| Auto | 1 | 7.89 | 7.25 | 0.5 |
| | 2 | 7.56 | | |
| | 3 | 7.83 | | |
| | 4 | 7.19 | | |
| | 5 | 6.26 | | |
| | 6 | 6.62 | | |
| | 7 | 7.49 | | |
| | 8 | 7.57 | | |
| | 9 | 6.70 | | |
| | 10 | 7.34 | | |

The test example compression short (Table 1) and the test example compression shirt (Table 2) were observed to provide sufficient air permeability to provide one or more of the performance attributes described above. For example, the air permeability was observed to provide sufficient levels to provide thermal management for the wearer.

The test example compression particulate blocking fabric was also tested for its performance in blocking particulates. The test was conducted in accordance with NFPA 1971:2018 for Efficiency of barrier flat sheet media. During the test, a test example compression shirt was subjected to a face velocity of 1 cm/sec with a flow direction orientation in which the outer surface of the test example compression shirt was facing upstream to the particulate flow. The conditions for the test was a temperature of 23 degrees Celsius, a relative humidity of 50.2% and a barometric pressure of 732.2 mmHg. The test example compression shirt was subjected to a contaminant comprising a latex sphere aerosol, polydispersed (neutralized). The performance of the test example compression in blocking various sizes of particulates is shown below in Table 3.

TABLE 3
Compression Shirt Particulate Blocking Test Results

| | | Particles at: (in microns) | | | | | | | |
|---|---|---|---|---|---|---|---|---|---|
| ID | Port | 0.10 | 0.16 | 0.30 | 0.50 | 0.60 | 0.70 | 0.81 | 1.00 |
| 1 | Upstream | 293019 | 343981 | 188643 | 119195 | 101840 | 89525 | 78085 | 68513 |
| | Downstream | 3051 | 5847 | 2132 | 1149 | 806 | 454 | 317 | 206 |
| | Efficiency(%) | 98.96 | 98.30 | 98.87 | 99.04 | 99.21 | 99.49 | 99.59 | 99.70 |
| 2 | Upstream | 309914 | 355490 | 195298 | 125806 | 105944 | 93484 | 85496 | 74316 |
| | Downstream | 2591 | 4727 | 2179 | 1055 | 711 | 521 | 339 | 251 |
| | Efficiency(%) | 99.16 | 98.67 | 98.88 | 99.16 | 99.33 | 99.44 | 99.60 | 99.66 |
| 3 | Upstream | 304205 | 351818 | 188648 | 121016 | 103807 | 90516 | 82400 | 71499 |
| | Downstream | 3570 | 6663 | 3269 | 1699 | 1053 | 746 | 450 | 313 |
| | Efficiency(%) | 98.83 | 98.11 | 98.27 | 98.60 | 98.99 | 99.18 | 99.45 | 99.56 |

As can be seen, the test compression particulate shirt can block particulates in the range of 0.10 microns to 1.00 microns with a blocking efficiency of at least 98% and in many instances the efficiency is greater than 99%.

Reference throughout this specification to “an example” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. An item of apparel formed from a compression particulate blocking fabric, the compression particulate blocking fabric comprising:
an outer layer;
a particulate blocking layer bonded to the outer layer, the particulate blocking layer configured to block particulates within a predetermined size range from passing through the particulate blocking layer; and
an inner layer bonded to the particulate blocking layer opposite to the outer layer;
wherein the compression particulate blocking fabric provides compression on a body part of a wearer of the item of apparel.

2. The item of apparel of claim 1, wherein the particulate blocking layer is configured to block particulates ranging from 0.1 microns to 1.0 microns in size.

3. The item of apparel of claim 2, wherein the particulate blocking layer is configured to block the particulates ranging from 0.1 microns to 1.0 microns at an efficiency of at least 98%.

4. The item of apparel of claim 1, wherein the outer layer and the inner layer are elastic materials operable in relaxed and expanded states to provide the compression on the body part of the wearer of the item of apparel.

5. The item of apparel of claim 1, wherein the particulate blocking layer comprises an ePTFE (expanded Polytetrafluoroethylene) material.

6. The item of apparel of claim 5, wherein the ePTFE (expanded Polytetrafluoroethylene) material is air-permeable.

7. The item of apparel of claim 5, wherein the outer layer is a Polyester and Spandex blend with a percentage Polyester in the range of 90% to 98% and a percentage Spandex in the range of 2% to 10%.

8. The item of apparel of claim 7, wherein the outer layer has a weight that is between or equal to 5 ounces per yard and 2 ounces per yard.

9. The item of apparel of claim 7, wherein the outer layer has a weight of about 2.2 ounces per yard.

10. The item of apparel of claim 8, wherein the inner layer is a Polyester and Spandex blend with a percentage Polyester in the range of 90% to 98% and a percentage Spandex in the range of 2% to 10%.

11. The item of apparel of claim 10, wherein the inner layer has a weight that is between or equal to 5 ounces per yard and 2 ounces per yard.

12. The item of apparel of claim 10, wherein the inner layer has a weight of about 2.2 ounces per yard.

13. The item of apparel of claim 1, wherein the compression particulate blocking fabric provides a compression pressure of up to 30 mmHG (millimeters of mercury) upon the body part of the wearer of the article when used.

14. A compression particulate blocking fabric comprising a particulate blocking layer bonded between two elastic layers, the compression particulate blocking fabric operable in a relaxed and in an expanded state in which the fabric blocks particulates ranging from 0.1 microns to 1.0 microns in size.

15. The compression particulate blocking fabric of claim 14, wherein the fabric has a percentage elasticity of at least 10%.

16. A method of making a compression particulate blocking fabric comprising;
laminating an outer layer to a particulate blocking layer, wherein the particulate blocking layer is configured to block particulates within a predetermined size range from passing through the particulate blocking layer;
allowing the laminated outer layer and particulate blocking layer to cure for a predetermined first cure time;
laminating an inner layer to the particulate blocking layer on a side of the particulate blocking layer opposite to the outer layer; and
allowing the laminated inner layer and particulate blocking layer to cure for a second predetermined cure time.

17. The method of claim 16, wherein the first predetermined cure time is at least 24 hours.

18. The method of claim 16, wherein the outer layer comprises a Polyester and Spandex blend with a percentage Polyester in the range of 90% to 98% and a percentage Spandex in the range of 2% to 10%.

19. A bonding system for making a multi-layered particulate blocking fabric having a particulate blocking layer bonded between an elastic outer layer and an elastic inner layer, the bonding system comprising:
a first dispenser for dispensing a first material comprising one of the elastic outer layer, the elastic inner layer or the blocking layer;
a second dispenser for dispensing a second material comprising one of a second one of the elastic outer layer, the elastic inner layer or the blocking layer;
a first tension controller coupled to the first dispenser and operable to maintain a tension of the first material at or below a first predetermined tension threshold; and
a second tension controller coupled to the second dispenser and operable to maintain a tension of the second material at or below a second predetermined tension threshold.

20. The bonding system of claim 19, further comprising:
a third dispenser for dispensing a first adhesive material between the first material and the second material; and
a third tension controller coupled to the third dispenser and operable to maintain a tension of the first adhesive material at or below a third predetermined tension threshold;
